(19) United States
(12) Patent Application Publication
(10) Pub. No.: US 2006/0024401 A1
(43) Pub. Date: Feb. 2, 2006

(54) Flow component for plastic material injection molding systems

(75) Inventors: Maurizio Bazzo, Oderzo (Treviso) (IT); Peter Dal Bo, Vittorio Veneto (Treviso) (IT)

Correspondence Address: HESLIN ROTHENBERG FARLEY & MESITI PC, 5 COLUMBIA CIRCLE, ALBANY, NY, 12203, US

(73) Assignee: INCOS S.p.A., San Polo di Piave (Treviso) (IT)

(21) Appl. No.: 11/154,424

(22) Filed: Jun. 16, 2005

(30) Foreign Application Priority Data
Jun. 16, 2004 (IT) TO2004A0004000

(51) Int. Cl. B29C 45/20

(52) U.S. Cl. 425/568

(57) ABSTRACT

A flow component (5) for systems for injection moulding of plastic materials having a flow passage (10) with an inlet (11) and an outlet (12), which together form an elbow (13), which has an internal projection (16) facing the inlet (11) and delimiting two areas (17) of doubling of the flow located immediately downstream of a guide passage (14) for a valve stem (8).

### FIELD OF THE INVENTION

The present invention relates in general to systems for injection moulding of plastic materials, and regards, more in particular, a flow component for such moulding systems.

By the term “flow component” it is meant, in the description and in the ensuing claims, an integral part or a part in the form of insert provided in a hot chamber, and particularly upstream of the body of an injection nozzle, having, for example, the function of valve bushing.

### STATE OF THE PRIOR ART

Traditionally, the above flow components comprise; a passage for flow of material having an inlet and an outlet for the fluid plastic material which, between them, form an elbow; and a guide passage communicating with said elbow in substantial alignment with the outlet and pre-arranged for receiving a valve stem in a slidable way.

In the case where the flow component is inserted into or integrated with a hot chamber upstream of the body of an injection nozzle, the valve stem is formed by a plug, which can displace axially for controlling introduction of the fluid plastic material from the nozzle into the mould, as described and illustrated, for example, in the European patent No. EP-B-1277560 filed in the name of the same present applicant. In this case, the plug, which is mobile through the guide passage of the flow component and extends through its outlet, is displaceable, for example by means of a linear actuator, between an advanced, closing, position and a retracted, opening, position with respect to the body of the injector nozzle.

In injection moulding of plastic materials it is of fundamental importance, for the purposes of quality of the moulded articles, to ensure a flow under pressure of the fluid plastic material within the mould that is as constant and regular as possible. In contrast with this need are the sharp variations in the path of flow of the plastic material to be injected, such as precisely the elbow (normally almost forming a right angle) between the inlet and the outlet of the flow component forming the subject of the invention. Sharp variations of this sort, in fact, entail slowing-down of the flow, which is even more accentuated by the presence of the valve stem, which is intercepted by the fluid plastic material precisely in an area corresponding to the elbow.

The above negative effects are further aggravated by the tendency of the plastic material to stagnate within the elbow, in an area corresponding to its wall facing the inlet of the passage for flow of material, i.e., behind the valve stem with respect to the direction of flow.

Various solutions have been proposed in an attempt to solve this problem.

In the case of the U.S. Pat. No. 6,524,093, provided between the inlet and the outlet of the passage for flow of material is a channel with decreasing cross section, which, in one embodiment (FIG. 10 of said patent), directs the flow of the plastic material around the valve stem.

Instead, the solutions proposed in the European patent application No. EP-A-0405007 and in the U.S. Pat. No. 4,705,473 envisage, between the inlet and the outlet of the passage for flow of material, a doubled duct.

The above solutions have proved inadequate also because, in certain cases, they aggravate the situation rather than improving it. The doubled duct requires in fact the presence of two elbows, thus substantially duplicating the drawbacks linked to a single elbow.

Proposed in the document No. WO-03/053653 (corresponding to U.S. Pat. No. B-6,752,618) is a solution in which the elbow is formed with an internal projection facing the inlet of the passage for flow of material, in a position diametrally opposite to said inlet, which bears upon a substantial dorsal portion of the plug set downstream. The projection constitutes a guide and an axial support for the plug itself.

The above solution is unsatisfactory in so far as the contact between the projection and the dorsal area of the plug produces, under the action of the thrust exerted by the flow of the fluid plastic material under pressure through the inlet, a localized wear of said dorsal area of the plug, which over time can give rise to malfunctioning.

### SUMMARY OF THE INVENTION

The purpose of the present invention is to solve the technical problem defined at the beginning of this description in a way that is effective, functional, but at the time same constructionally simple and inexpensive.

According to the invention, the above purpose is achieved thanks to the fact that, in a flow component of the type defined above, the elbow is formed with an internal projection facing the inlet of the passage for flow of material, which is set at a distance from the plug and delimits two areas of at least partial doubling of the flow of plastic material downstream of said guide passage with respect to the direction of the flow of plastic material.

According to a preferred embodiment of the invention, the aforesaid two areas of at least partial doubling of the flow present a general spiral or else helical, configuration.

Thanks to this idea of solution, in use, when the fluid plastic material reaches the elbow of the flow passage, it circumvents on either side the valve stem following the two areas of doubling of the flow, without any appreciable reduction in speed and preventing any stagnation behind the open-close element.

Furthermore, the restriction of the area of flow due to the presence of the internal projection of the elbow brings about an increase in the local rate of the flow of fluid plastic material, which further improves the conditions of flow.

The geometrical shape of a double helix of the wall of the elbow facing the inlet of the passage for flow of material can be obtained in a simple and economically advantageous way by means of machining with removal of stock, for instance, using numeric-control milling machines, or else by means of electron-discharge machining, lost-wax moulding, MIM (Metal Injection Moulding) technology, and the like.

### DESCRIPTION OF THE DRAWINGS

The invention will now be described in detail with reference to the annexed plate of drawings, which are provided purely by way of non-limiting example and in which:

FIG. 1 is a partially sectioned schematic view of an injector nozzle for moulding of plastic materials incorporating a flow component according to the invention;

FIG. 2 is a side elevation at an enlarged scale of the flow component of FIG. 1;

FIG. 3 is a view in axial section according to the line III-III of FIG. 2;

FIG. 4 is a schematic perspective view and at an enlarged scale that shows the configuration of the elbow within the flow component of FIGS. 1 to 3;

FIG. 5 is a sectioned perspective view at an enlarged scale of the flow component of FIG. 3; and

FIG. 6 is a view similar to FIG. 3 illustrating a similar flow component according to the prior art.

### DETAILED DESCRIPTION OF THE INVENTION

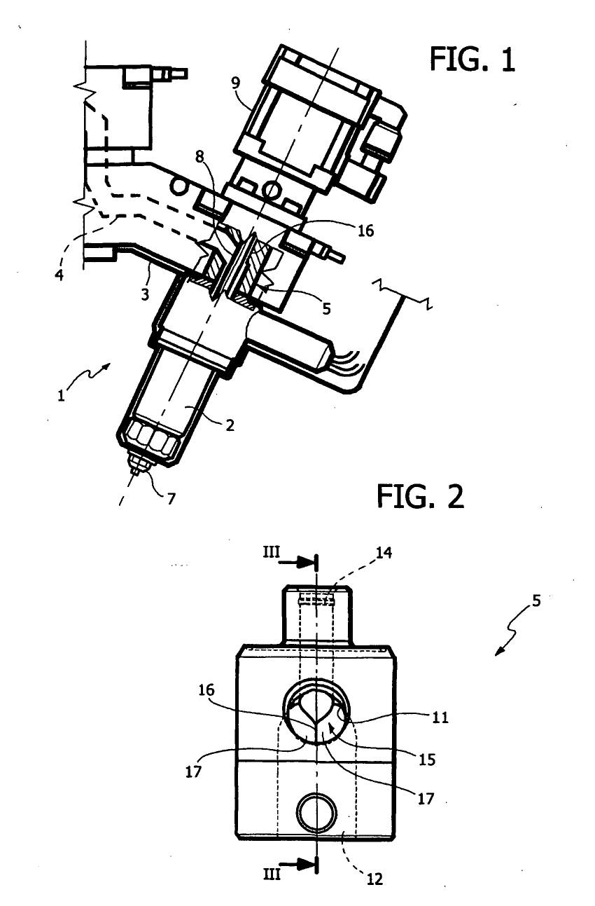

With initial reference to FIG. 1, number 1 designates as a whole an injector nozzle for injection of plastic materials into a mould, said injector basically consisting of a tubular body 2 projecting from a hot chamber 3 provided with a hot channel 4 for supply of the fluid plastic material to be injected. The duct 4 communicates with the cavity of the body 2 of the nozzle 1 through a bushing 5, by means of which the flow of fluid plastic material is deflected within the tubular body 2 towards a terminal part 7 of the nozzle 1, from which the plastic material is injected into the mould.

Passage of the plastic material through the terminal part 7 is controlled by means of a valve stem formed by an axial plug 8, which is guided in a slidable way through the bushing 5 and can be displaced axially along the cavity of the body 2 between an advanced position for closing the passage through the terminal part 7 and a retracted position for opening said passage. The displacement of the plug 8 between the advanced position and the retracted position is controlled, in a generally conventional way, via a linear actuator, for example, a fluid actuator, 9, or equivalent systems.

The bushing 5 constitutes an example of embodiment of the flow component according to the invention. In the embodiment exemplified, the flow component defined by the bushing 5 consists of an insert applied by pressure, or with equivalent systems, within the hot chamber 3; it is, however, to be emphasized that the modalities for its application could be different, and moreover that it may not necessarily be an insert. In other words, the peculiar geometrical characteristics that will be described in what follows could find application also in a flow component integrated with the hot chamber 3.

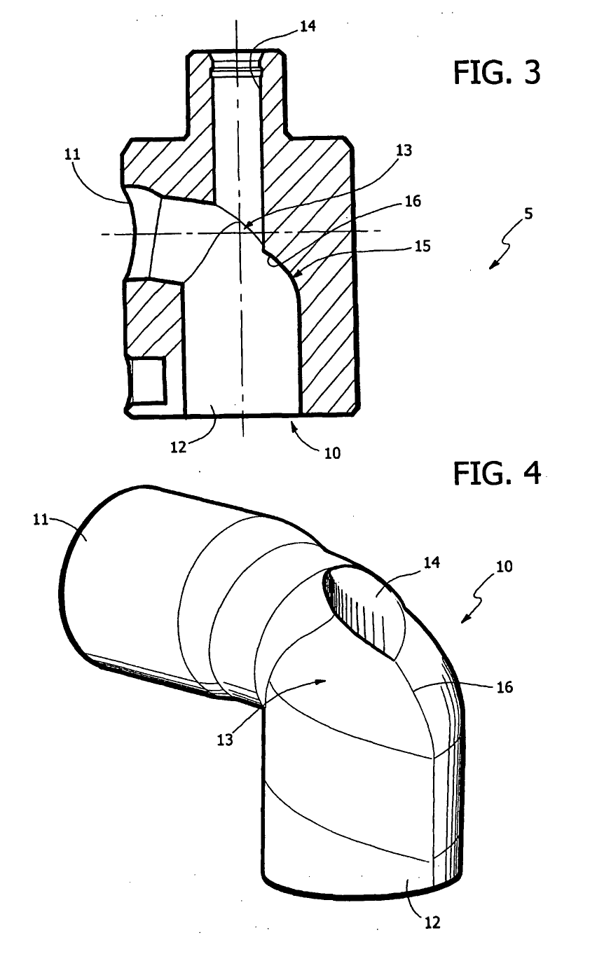

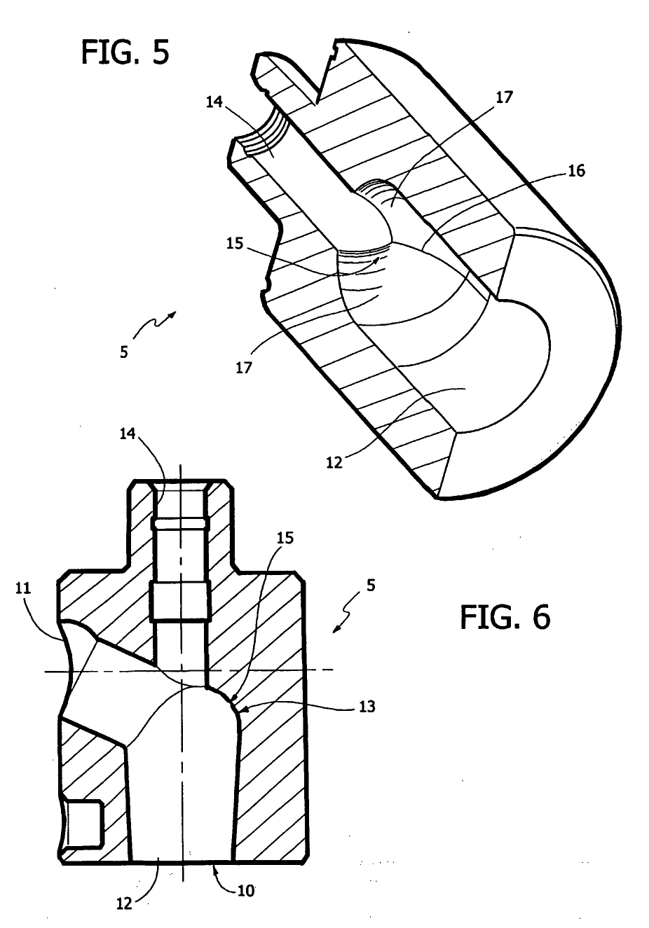

With reference now in greater detail to FIGS. 1 to 5, the flow component constituted by the bushing 5 consists of a generally cylindrical body formed entirely with a flow passage 10 having an inlet 11, set in communication with the hot channel 4, and an outlet 12 set in communication with the cavity of the body 2 of the injector nozzle 1, coaxially thereto. The inlet 11 and the outlet 12 communicate with one another through an elbow 13, with an angle slightly greater than 90°, in an area corresponding to which there converges a guide passage 14, which is also coaxial with the cavity of the body 2 of the injector nozzle 1 and hence with the outlet 12 of the flow passage 10. The guide passage 14 is traversed in a slidable way by the plug 8, which extends through the outlet 12 beyond the bushing 5, along the cavity of the body 2 of the injector nozzle 1.

The arrangement so far described is generally similar to the one according to the known art represented in FIG. 6, in which parts that are identical or similar to the ones described above are designated by the same reference numbers. In the conventional bushing 5 of FIG. 6, the elbow 13 defined between the inlet 11 and the outlet 12 of the flow passage 10, originated simply following upon the convergent millings of the inlet 11 and outlet 12, has a regular geometrical shape. The part of the wall of the elbow 13 facing the inlet 11 and located immediately downstream of the guide passage 14, with reference to the direction of flow of plastic material through the passage 10, is designated by 15. Said part, which is consequently located behind the valve stem 8 that extends through the guide passage 14, the elbow 13, and the outlet 10, delimits an area of both slowing down and stagnation of the fluid plastic material, which, in use, traverses the elbow 13.

The invention differs in a new and original way from the prior art thus described with reference to FIG. 6 as regards the configuration of the elbow 13, and more in particular as regards the configuration of the part 15 of its wall facing the inlet 1. According to the invention, said part of wall 15 is formed with an internal median projection 16, which delimits two areas 17 of at least partial doubling of the flow of plastic material immediately downstream of the guide passage 14, and hence immediately behind the valve stem 8 with respect to the direction of flow of plastic material through the elbow 13.

The projection 16 is set at a radial distance, albeit slightly, from the plug 8 and is consequently not in contact with the dorsal surface of the plug 8 facing it.

The two areas 17 located at the opposite sides of the projection 16 conveniently have a general spiral configuration, and, even more advantageously, a helical conformation. Said configuration can be obtained by means of machining with removal of stock, for example with the use of numeric-control milling machines, or else with other equivalent technologies such as, for example, electron-discharge machining, fast prototyping, lost-wax moulding, MIM technology, and the like.

As has already been clarified previously, in use, the flow of fluid plastic material coming from the hot channel 4 within the inlet 11 of the flow passage 10 traverses the elbow 13, in part reaching directly the outlet 10, and in part circumventing the valve stem 8 without any reduction of local rate of flow, but rather, at an increased rate on account of the restriction in cross section due to the presence of the projection 16, as well as to the double-spiral or double-helix conformation of the areas 17, and above all without any risk of stagnation thanks to the doubling of the flow performed by the two spiral or helical areas 17.

In practice, this makes it possible to ensure levels of performance of injection of the plastic material within the mould that are constant and optimal. Furthermore, the distance between the projection 16 and the dorsal surface of the plug 8 which faces it does not adversely affect proper operation of the latter.

Of course, the details of construction and the embodiments may vary widely with respect to what is described and illustrated herein, without thereby departing from the scope of the present invention, as defined in the ensuing claims.

Thus, as has already been explained previously, the flow component 5 according to the invention can consist, rather than of an insert, of an integral part of the hot chamber 3 or a component thereof.

What is claimed is:

1. A flow component (5) for systems for injection moulding of plastic materials, including a passage for flow of material (10) having an inlet (11) and an outlet (12) for the fluid plastic material, forming between them an elbow (13), and a guide passage (14) which communicates with said elbow (13) in substantial alignment with said outlet (12) and is pre-arranged for receiving in a slidable way a valve stem (8), wherein said elbow (13) is formed with an internal projection (16) facing said inlet (11) which is set at a distance from said plug (8) and delimits two areas (17) of at least partial doubling of the flow of plastic material immediately downstream of said guide passage (14) with respect to the direction of flow of the plastic material.

2. The flow component according to claim 1, in which said two areas (17) of at least partial doubling of flow have a generally spiral configuration.

3. The flow component according to claim 1, in which said two areas (17) of at least partial doubling of the have a generally helical configuration.

4. The flow component according to claim 1, consisting of a valve-bushing insert (5) applied to a hot chamber (3).

5. The flow component according to claim 1, formed integrally in a hot chamber (3).

6. The flow component according to claim 1, in which said valve stem consists of the plug (8) of an injector nozzle (1).
